(19) United States
(12) Patent Application Publication
(10) Pub. No.: US 2019/0109457 A1
(43) Pub. Date: Apr. 11, 2019

(54) SYSTEM AND METHOD FOR POWER LOAD SHEDDING ASSOCIATED WITH A DEMAND RESPONSE PROGRAM

(71) Applicant: Panoramic Power Ltd., Kfar-Saba (IL)

(72) Inventors: Theodor FLATAU, Ein Vered (IL); Amir ALROD, Tel Aviv (IL); Adi SHAMIR, Kidron (IL)

(73) Assignee: Panoramic Power Ltd., Kfar-Saba (IL)

(21) Appl. No.: 16/152,614

(22) Filed: Oct. 5, 2018

Related U.S. Application Data
(60) Provisional application No. 62/569,510, filed on Oct. 7, 2017.

(51) Int. Cl. H02J 3/14; G05B 13/04; G05B 13/02

(52) U.S. Cl. CPC H02J 3/14; H02J 2003/007; G05B 13/0265; G05B 13/042

(57) ABSTRACT

A system and method for power load shedding assessment associated with a demand response program, including: setting a power load shedding target; analyzing data related to power consumption of a system; determining a configuration of a plurality of virtual switches associated with a corresponding plurality of physical switches, where each of the plurality of physical switches is configured to control power consumption of at least one load of a plurality of loads of the system; simulating a power load shedding event based on the setup of a plurality of virtual switches and the analyzed data related to power consumption; and adjusting the configuration of the virtual switches when results of the simulating of a power load shedding event are not consistent with the power load shedding target.

### CROSS-REFERENCE TO RELATED APPLICATIONS

This application claims the benefit of U.S. Provisional Application No. 62/569,510 filed on Oct. 7, 2017, the contents of which are hereby incorporated by reference.

### TECHNICAL FIELD

The present disclosure relates generally to energy management, and more specifically to power load shedding management associated with a demand response program.

### BACKGROUND

Demand response programs are programs designed to balance the demand of energy, such as electricity provided by a power provider, with available power supply. These programs attempt to incentivize consumers of electricity to shift their usage to more favorable time periods, which are often off-peak times where average power usage is lower than peak periods. Enrollment in such demand response programs may require a consumer to commit to a program operator, such as an aggregator or a utility provider, to shed a predetermined amount of power consumption, otherwise being used, when a power shedding event is called upon. Commitment to such curtailment is required at the enrollment stage. Inability to comply to a power shedding commitment may result in loss of the demand response revenue for the year, agreed upon penalties, and fines. In some cases the consumer may risk the loss of the entire demand response contract. This creates a difficulty in the sales process for such programs, as the consumer would like to have a high-level of confidence in their ability to commit to a certain amount of load reduction.

As consumers very often do not possess complete relevant data, and the commitment to such programs is done solely on the basis of prior utility bills and load speculations, commitment is typically much lower than what could successfully be committed to. Therefore, both the consumer and the aggregator lose out, as they are unable to realize full potential revenues. Moreover, the lack of data also complicates the process of planning what should be the optimal response in the case a power load shedding event is called for in terms of which loads should be turned off. Understandably, a consumer wishes to have the freedom to curtail loads which will on the one hand provide sufficient power to meet the commitment, and on the other hand maintain an as normal as possible operation of their business. These desires may include, but are not limited to, maintaining, in a landlord context, tenants' comfort when the curtailed load is taken from a heat, ventilation, and air-conditioning (HVAC) system and keeping, in a manufacturer context, production running at sufficient pace when the curtailed load is taken from machines of a production line.

There is currently no solution to easily enable consumers to increase their confidence when enrolling in such a demand response program, allowing commitment to the maximum curtailable load, as well as enabling planning a response to a power load shedding event in a way that allows the flexibility of meeting the commitment without negatively affecting the normal course of business. Current methods require intensive manual involvement in deciding what demand response plan may be used and tends to determine power load shedding either arbitrarily, risking not meeting the requirements of the demand response program, or not taking full advantage of the program by committing to lower power shedding levels than can be safely undertaken.

It would therefore be advantageous to provide a comprehensive solution, preferably automated, to overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for power load shedding assessment associated with a demand response program, including: setting a power load shedding target; analyzing data related to power consumption of a system; determining a configuration of a plurality of virtual switches associated with a corresponding plurality of physical switches, where each of the plurality of physical switches is configured to control power consumption of at least one load of a plurality of loads of the system; simulating a power load shedding event based on the setup of a plurality of virtual switches and the analyzed data related to power consumption; and adjusting the configuration of the virtual switches when results of the simulating of a power load shedding event are not consistent with the power load shedding target.

Certain embodiments disclosed herein also include a system for assessment of power load shedding associated with a demand response program, the system including: a processing circuitry; and a memory, the memory containing instructions that, when executed by the processing circuitry, configure the system to: set a power load shedding target; analyze data related to power consumption of a system; determine a configuration of a plurality of virtual switches associated with a corresponding plurality of physical switches, where each of the plurality of physical switches is configured to control power consumption of at least one load of a plurality of loads of the system; simulate a power load shedding event based on the setup of a plurality of virtual switches and the analyzed data related to power consumption; and adjust the configuration of the virtual switches when results of the simulating of a power load shedding event are not consistent with the power load shedding target.

Certain embodiments disclosed herein also include a system for assessment of power load shedding associated with a demand response program, the system including: at least one power sensor configured to determine power consumption; a processing circuitry; and a memory, the memory containing instructions that, when executed by the processing circuitry, configure the system to: set a power load shedding target; analyze data related to power consumption of a system; determine a configuration of a plurality of virtual switches associated with a corresponding plurality of physical switches, where each of the plurality of physical switches is configured to control power consumption of at least one load of a plurality of loads of the system; simulate a power load shedding event based on the setup of a plurality of virtual switches and the analyzed data related to power consumption; and adjust the configuration of the virtual switches when results of the simulating of a power load shedding event are not consistent with the power load shedding target.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system for power load shedding associated with a demand response program according to an embodiment.

FIG. 2 is a screenshot of a simulation for a demand response program according to an embodiment.

FIG. 3 is a screenshot of a plan for a demand response program according to an embodiment.

FIG. 4 is a flowchart of a process for checking a switch setup for a demand response program according to an embodiment.

FIG. 5 is a flowchart of a process for deployment of a power load shedding plan to support a desired demand response program according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for power load shedding in the context of a demand response program. The system includes a plurality of power sensors that sense power consumed by a plurality of power consumers. Information from the power sensors is gathered and collected, providing data for the behavior of power consumption over determined periods of time. The total power consumption by the consumers is measured, and may be displayed, along with a plurality of virtual switches corresponding to each of the power sensors, where each switch includes an ‘on’ position, ‘off’ position, and various positions therebetween to allow for adjustment of the amount of power drawn by a particular load circuit. A target load shedding amount is set and the system performs, for example by machine learning, a process of switch control to simulate temporal power consumption that may meet the desired load shedding figure and determine a commitment level. The position of one or more plans for a load shedding amount may be used for actual load shedding when necessary by invoking physical switches associated with the plurality of power consumers.

Without limiting the scope of the present disclosure, it is noted that the system described herein is applicable to any demand management program operated by a program operator, whether the operator is a utility, a regulatory body, an aggregator, a grid operator or self-managed by the company itself. It is further noted that the term and definition of ‘demand response’ may vary in different regions and geographies and therefore it should be clarified that the system described herein is applicable to any demand management program operated by any demand management program operator designed to shed loads in order to reduce peak demand for electrical power, generate revenues or save costs. All such programs shall be referred to herein as ‘demand response’ programs.

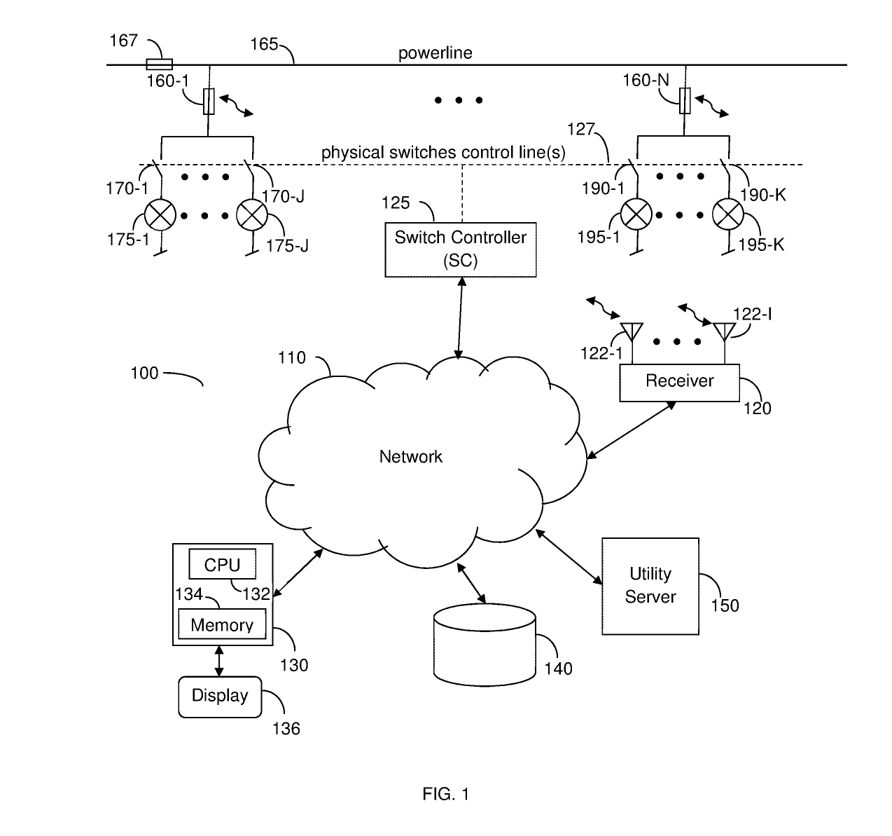

FIG. 1 is a network diagram of a system 100 for power load shedding associated with a demand response program according to an embodiment. The system may operate in three phases that include collection of relevant data, performing simulations of load shedding for demand response programs, and applying a particular demand response program when a demand is received for load shedding. A power line 165 may feed a plurality of loads, where each feed is monitored by a power sensor 160. The power sensors 160, e.g., power sensors 160-1 through 160-N, where N is a number equal to or greater than 1, may be self-power power sensors (SPPSs), the likes of which that have been described in U.S. Pat. No. 9,720,018 titled “Apparatus and Methods Thereof for Power Consumption Measurement at Circuit Breaker Points”, assigned to common assignee and hereby incorporated by reference for all that it contains.

Each power sensor 160 senses the power provided to one or more power consuming loads. For example, power sensor 160-1 measures the power consumption by loads 175-1 through 175-J, where J is equal to or greater than 1, while power sensor 160-N measures the power consumption by loads 195-1 through 195-K where K is equal to or greater than 1. A power sensor 167 may also be connected to the main power line 165 in order to measure the total power consumed from the grid. In another embodiment, the total power consumed from the grid can be calculated as an aggregate of all the sensor data measuring individual loads, assuming all loads are measured.

In yet another embodiment, the main power or any of the individual loads' power can be measured by a utility meter and provided to the system via a data logger or bridge associated with the above utility meter using, for example but not by way of limitation, a physical connection to the utility meter or another physical connection such as Modbus® (trademark of Schneider Electric USA, Inc,) serial communication protocol. Other types of meters or sensors may also be used. Measuring the mains' power is used to compare the actual total consumption with the demand response program target. In some embodiments, the main power data is collected directly from the utility server 150 or via utility bills.

Each load may be further connected to a switch, for example, load 175-1 may be connected to switch 170-1 while load 195-1 may be connected to switch 190-1. While the switches 170 and 190 are shown as ON/OFF switches in FIG. 1, this is not meant to be limiting and such switches, on an individual basis, may allow the control of power through the switch either in step or continuously between the ON and OFF positions. That is, a switch may cause the load to use only 50% of the power it would use in an otherwise ON position. As an example, but not by way of limitation, such a function may be similar to that of a light dimmer where if less power is to be consumed, the dimmer may be adjusted such that the source of light receives less power and hence provides less light. In an industrial example, a conveyer belt may be operated at a lower speed in order to conserve energy. Any such position can be a discrete operational state or a continuous power draw depending on the implementation and specific type of load. The switches may be controlled by a switch controller (SC) 125 communicatively connected to the switches 170 and 190 by, for example but not by way of limitation, control line(s) 127. Control may be used physically for the measurement collection phase and for the effecting the demand response plan phase of power shedding.

The SC 125 is communicatively connected to a network 110 through which the SC 125 is controlled. The network 110 may be a local area network (LAN), a wide area network (WAN), a metro area network (MAN), the Internet, the worldwide web (WWW), and any other suitable network, as well as any combination thereof. The network itself may be wireless, wired, or a combination of both. The network 110 is further connected to a database 140 configured to store measurements sampled by the power sensors 160, where each sample provides information related to power consumed and the time of such consumption.

A plurality of readings over time may provide data of the usage of power by the loads over a period of time, as well as the behavior when a particular load is operative or not. Such data may be used during a simulation phase to determine one or more optimal demand response plans based on various constraints. The network 110 is further connected to a utility server 150 that contains information regarding demand response programs that may be applicable and/or available. This information may be accessed for the purpose of determining the benefits that a utility company may provide as a result of adhering to a particular demand response plan. In an embodiment, the utility server may be accessed over the Internet.

For the purpose of receiving information from the plurality of power sensors 160, a receiver 120 is further connected to the network 110. The receiver 120, equipped with one or more antennas 122, is adapted to receive signals from each of the power sensors 160, the signals containing information regarding the power measurements made by each such power sensor 160 as well as the time when such a sample took place. One or more receivers 120 can be used in tandem. In an embodiment, the receiver is a wireless receiver, operating over radio waves. While the receiver 120 herein is described only as a receiver, in further embodiment, the receiver 120 may be replaced by a transceiver (not shown) that may both receive and transmit signals from and to the power sensors 160. Such a transceiver may enable the control of the power sensors 160, for example, but not by way of limitation, for synchronization, calibration, and other purposes.

The network 110 is further connected to a processor 130 that may be further connected directly or indirectly to a display 136. The processor 130 may further include a central processor (CPU) 132 communicatively connected to a memory 134, where the memory 134 may contain instructions to be executed by the CPU 132. In one embodiment the instructions, when executed by the CPU 132, configure the processor 130 to operate as a learning machine, as further explained herein. In one embodiment the receiver 120 may be an integrated within the processor 130. In one embodiment, the receiver 120 further includes a wired interface (such as pulse input or a Modbus®) to receive data from the sensors 160, and particularly, but not limited to, a utility meter that is measuring the power from the main powerline.

During the collection phase of the operation of system 100, data from the plurality of power sensors 160 are received by the receiver 120. This includes, e.g., power samples and timing information, and may be sent to the processor 130 according to one or more programs stored in the memory 134. Accordingly, calculation of power consumption may be made and then stored in, e.g., the database 140. Upon accumulation of sufficient data, such information may be graphically displayed on the display 136.

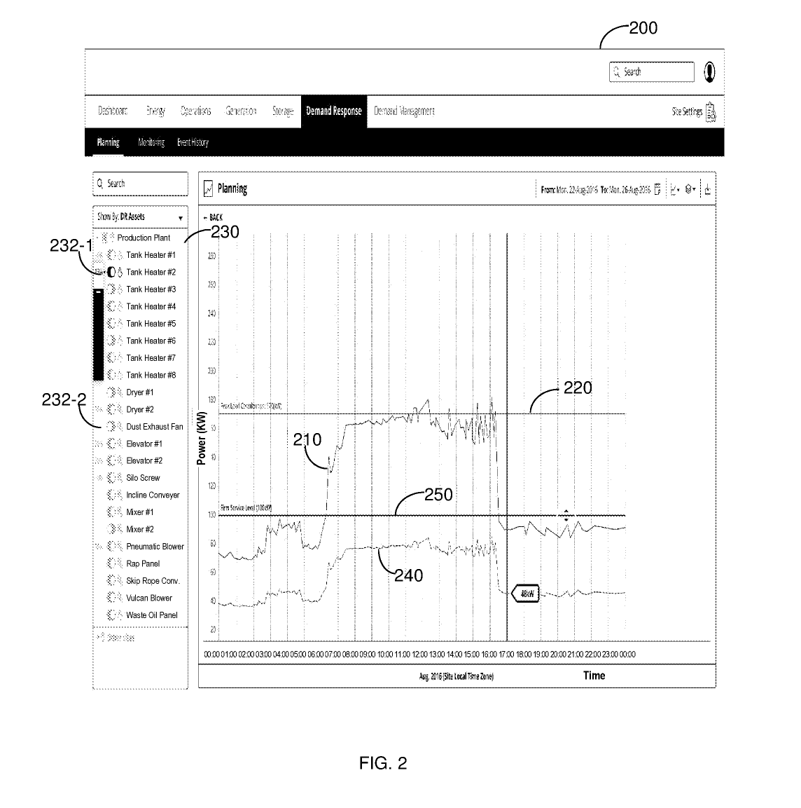

FIG. 2 is a screenshot 200 of a simulation for a demand response program according to an embodiment. The horizontal axis of the graph describes a period of twenty four hours and the vertical axis describes power consumption. The actual consumption of a site being analyzed is described by the curve 210. It should be noted that the value shown for any particular time within these twenty four hours may be determined in a variety of methods and based on particular rules provided, for example, from the utility server 150. The graph shown may be drawn for a particular quarter of the year (e.g., summer consumption, winter consumption, etc.), a particular month of the year (e.g., January, February, etc.), a particular week (e.g., workweek 1, workweek 2, etc.) of the year, and so on.

A calculation is performed on the historical consumption of the site stored, for example, in database 140. As an example calculation, an average of the power consumption in the last four highest similar days, e.g., weekdays, weekends, holidays, may be used. Based on the consumption curve 210 and specific rules set by each demand response program provided, for example by the utility server 150 of FIG. 1, a specific baseline 220 is determined by a processor, e.g., the processor 130 of FIG. 1. The baseline 220 may be a constant line (as shown in FIG. 2), have a curve with different values at different hours of the day, or can be calculated each day separately, depending on the specific demand response program requirements as provided by the program operator. The baseline 220 is a load level from which future power shedding is calculated to meet a target set by a demand response program.

Once sufficient data has been received, a simulation of one or more potential situations for power shedding may be simulated by the processor 130. Every switch, e.g., switches 170 and 190 of FIG. 1, may be displayed in panel 230 shown in FIG. 2. The position of each switch may be determined either manually by a user viewing the display, or by the processor 130 operating under instructions being executed by the CPU 132, using, for example but not by way of limitation, machine learning techniques or other optimization techniques to determine optimal positions for each such virtual switch 232-1, 232-2, etc. (not shown in any particular order in FIG. 2). Moreover, such an operation may take into account additional information, e.g., the priority in shedding power from one load versus another. For example, switching off an air-conditioning device may take priority over switching off lights in a retail store, as slight discomfort to customers may be determined to be preferable to complete darkness.

In FIG. 2, one virtual switch 232-1 is activated (highlighted) while all other virtual switches, including switch 232-2, are deactivated (dimmed) for the simulation purposes. The power consumption of the load controlled by virtual switch 232-1 is shown in curve 240. This may now be compared to a demand response target for power load shedding to a level described by curve 250. It should be understood that though the curve 250 is shown as a straight line other curves are also possible and are included within the scope of this disclosure. As curve 240 is below curve 250, the simulation suggests that a company may be committing to the power load shedding program agreed upon with a particular demand response program provider. For example the consuming entity may feel confident in committing to a load shedding program for a base load 220 of 170 KW to a target 250 of 100 KW, as the curve 240 is entirely below the target. An additional 20 KW is available for shedding, as the curve 240 reaches 80 KW at its highest position and therefore the company could have decided to commit to save an extra 20 KW.

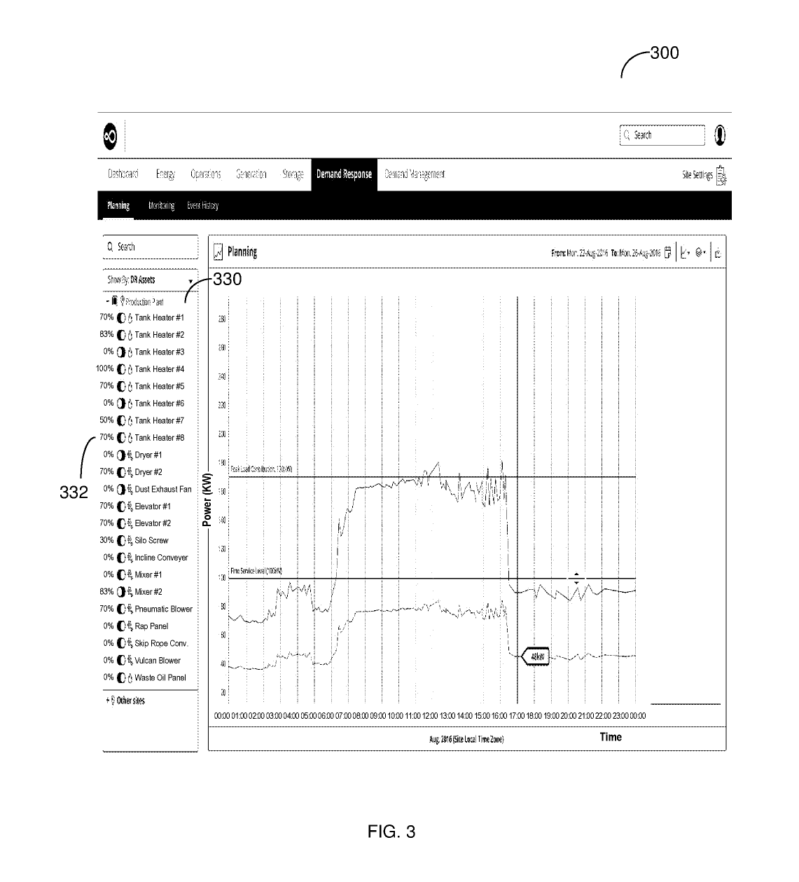

A particular plan is shown in FIG. 3, as an example screenshot 300 of a plan for a demand response program, according to an embodiment. The settings of the virtual switches to meet the particular plan is shown as highlighted in either OFF (0%), ON (100%) or percentage of consumption between the ON and the OFF positions (e.g., 70%) 332. According to an embodiment, when this plan is to be activated, the SC 125 receives the information of the plan and switches the physical switches 170 and 190 accordingly to their respective positions in accordance with the selected plan.

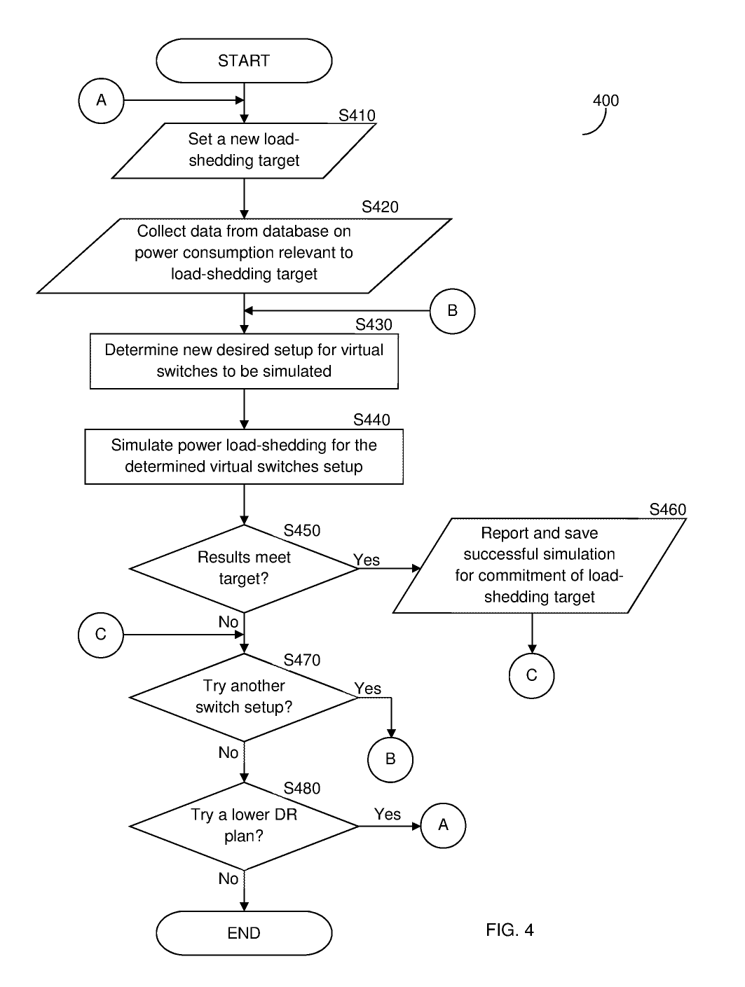

Reference is now made to FIG. 4 that depicts a flowchart 400 of a process for checking a switch setup for a demand response program according to an embodiment.

At S410, a preliminary target demand response plan is set, where the target includes a power load shedding target. The preliminary target may be: a) manually set by the user of the system, based upon some availability of demand response load program by a program operator; b) provided as a target by an entity other than the user that provides such targets, for example but not by way of limitation, a regulator, a utility provider, and the like, by means of data available on the utility server 150; or, c) by machine learning performed, for example but not by way of limitation, by the processor 130 of FIG. 1. In the case where a target is provided by a entity other than the user, various targets may be set, e.g., a maximum target, and minimum target, and an average usage target, and the like.

At S420, data of samples stored, for example in database 140, of measurements of power consumption that are relevant to the received target demand response plan is collected for the purpose of generating the power consumption over a predefined period of time, for example 24 hours, as shown in the screenshot of FIG. 2. The collected data is analyzed to determine power consumption.

At S430, a previously undetermined desired setup of virtual switches is determined. This may be done in various methods, including: a) manually by using a user interface on the display 136 showing the switches and sliding them, or setting them, to a desired setting, ON, OFF or any possible value in between if such possibility exists; b) automatically by applying various algorithms and/or machine learning and/or previous knowledge stored in the database 140; or, c) any combination between a manual and automatic setup, i.e., having a user setup some of the virtual switches and let the rest be setup by the machine.

At S440, the power consumption for the desired period of time may be calculated for the particular virtual switches setup. In one embodiment this may be displayed on the display 136. In an embodiment, a simulation of a power load shedding event is executed, based on the configuration of the virtual switches and the power consumption data.

At S450, it is checked whether the results are consistent with the demand response load shedding target and if so, execution continues with S460; otherwise, if the results are not consistent with the target, execution continues with S470.

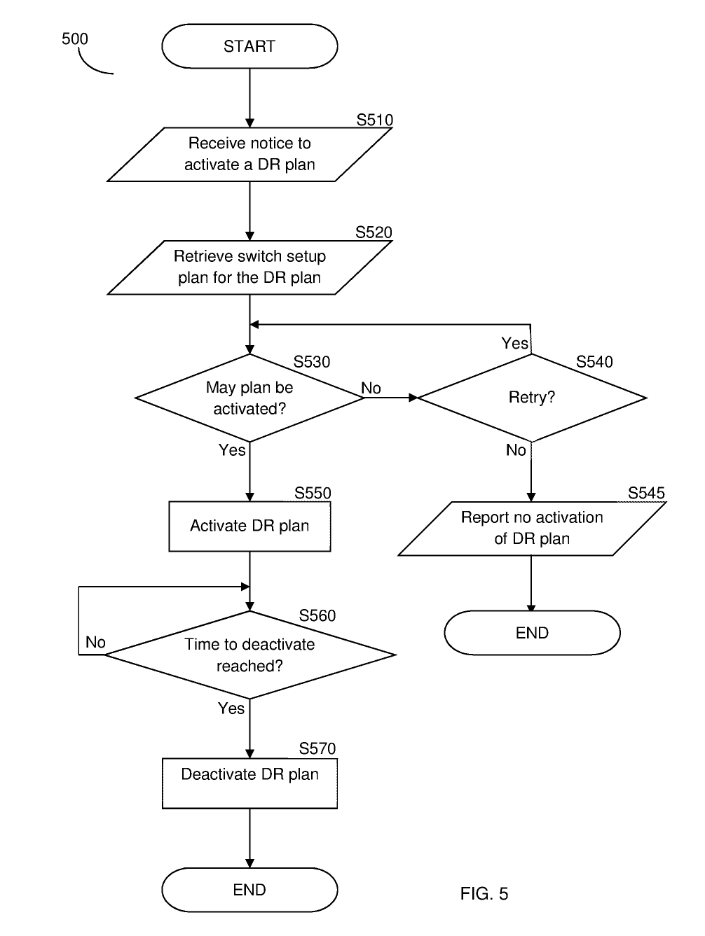

At S460, it is reported that a desired setup for the virtual switches has been found that meets the target load shedding figure, and that the power load shedding plan is stored, for example in database 140, for the purpose of future activation, and as further discussed with respect of FIG. 5. In one embodiment, thereafter S460 execution terminates. In another embodiment, subsequent too S460 execution continues with S470 so that potentially other setups of the switches may be found, or even a better commitment plan.

At S470, it is checked if it is desirable to check another possible virtual switch setup, as it may be possible to find another set up that will meet the demand response load shedding target, and if so execution continues with S430; otherwise, execution continues with S480. Thus, at S470, the configuration of the virtual switches is adjusted to optimize power consumption within the power load shedding target.

At S480, it is checked whether another demand response load shedding target can be obtained, as it is possible that the user may be able to commit to shedding additional load, and if so execution continues with S410; otherwise, execution terminates.

FIG. 5 shows a flowchart 500 of a process for activating of a power load shedding plan to support a desired demand response program according to an embodiment.

At S510, the system, for example system 100, receives a notice that a particular demand response plan is to be activated. This is often referred to as a demand response event. The signal can be received from the utility server 150. The notice can be given ahead of time or in real time, depending on the type of program.

At S520, the switch setup for that particular demand response plan is retrieved, for example from database 140. At S530, it is checked if the plan may be activated and if so execution continues with S550; otherwise, execution continues with S540. At S540, it is checked whether the system should retry and if so execution continues with S530; otherwise, execution may continue with a notification at S545 to the program operator that the power load shedding request has been denied after which execution terminates. Such denial may have consequences on the power consumer that may result in losing the demand response revenue, fines or higher utility costs and therefore embodiments where additional checks and authorization for not meeting the demand response target during such an event may be added without departing from the scope of the present disclosure. Data is collected during the event and saved for settlement purposes after the event.

At S550, the plan is activated by setting the physical switches, for example switches 170 and 190 of system 100, to their planned position. At S560, it is checked whether a notice to deactivate the demand response event has been received and if so execution continues with S570; in a typical embodiment deactivation of an event is pre-determined by setting an event to a particular length of time, e.g., two hours, and thereafter the event automatically ends; otherwise, execution continues with S560.

At S570, the demand response plan is deactivated. For example, the physical switches, e.g., switches 170 and 190 of system 100, are returned to their position prior to the change. In one embodiment of the present disclosure a recovery setup plan may be also used before resuming normal operation and should be viewed to be within the scope of the present disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processors (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for power load shedding assessment associated with a demand response program, comprising:
setting a power load shedding target;
analyzing data related to power consumption of a plurality of loads of the system;
determining a configuration of a plurality of virtual switches associated with a corresponding plurality of physical switches, wherein each of the plurality of physical switches is configured to control power consumption of at least one load of the plurality of loads of the system;
simulating a power load shedding event based on the setup of the plurality of virtual switches and the analyzed data related to power consumption; and
adjusting the configuration of the virtual switches when the simulation results of a power load shedding event are not consistent with the power load shedding target.

2. The method of claim 1, further comprising:
storing the adjusted configuration of the virtual switches in a database for future reference.

3. The method of claim 1, wherein analyzing data related to power consumption further comprises:
collecting from a plurality of power sensors information of power consumed by the plurality of loads, where each load of the plurality of loads is associated with a respective power sensor of the plurality of power sensors.

4. The method of claim 1, wherein determining the configuration of a plurality of virtual switches is performed by machine learning.

5. The method of claim 1, wherein setting the power load shedding target comprises:
receiving the load shedding target from a user using a user interface.

6. The method of claim 1, wherein setting the power load shedding target comprises:
determining the load shedding target for the system based on machine learning.

7. The method of claim 1, wherein setting the load shedding target further comprises:
receiving the load shedding target from a database containing a plurality of load shedding targets.

8. The method of claim 1, wherein the configuration of each of the plurality of virtual switches includes at least one of: an on position, and off position, and an intermediate position.

9. The method of claim 1, where determining the configuration of a plurality of virtual switches includes assigning priority among the plurality of loads of the system with regard to the power load shedding event.

10. A non-transitory computer readable medium having stored thereon instructions for causing a processing circuitry to perform the method of claim 1.

11. A system for assessment of power load shedding associated with a demand response program, the system comprising:
a processing circuitry; and
a memory, the memory containing instructions that, when executed by the processing circuitry, configure the system to:
set a power load shedding target;
analyze data related to power consumption of a plurality of loads of the system;
determine a configuration of a plurality of virtual switches associated with a corresponding plurality of physical switches, wherein each of the plurality of physical switches is configured to control power consumption of at least one load of a plurality of loads of the system;
simulate a power load shedding event based on the setup of the plurality of virtual switches and the analyzed data related to power consumption; and
adjust the configuration of the virtual switches when results of the simulating of a power load shedding event are not consistent with the power load shedding target.

12. The system of claim 11, wherein the system is further configured to:
store the adjusted configuration of the virtual switches in a database for future reference.

13. The system of claim 11, wherein the system is further configured to:
collect from a plurality of power sensors information of power consumed by the plurality of loads, where each load of the plurality of loads is associated with a respective power sensor of the plurality of power sensors.

14. The system of claim 1, wherein determining the configuration of the plurality of virtual switches is performed by machine learning.

15. The system of claim 11, wherein the system is further configured to:
receive the load shedding target from a user using a user interface.

16. The system of claim 11, wherein the system is further configured to:
determine the load shedding target for the system based on machine learning.

17. The system of claim 11, wherein the system is further configured to:
receive the load shedding target from a database containing a plurality of load shedding targets.

18. The system of claim 11, wherein the configuration of each of the plurality of virtual switches includes at least one of: an on position, and off position, and an intermediate position. Page 16 of 24

19. The system of claim 11, wherein the system is further configured to:
assign priority among the plurality of loads of the system with regard to the power load shedding event.

20. A system for assessment of power load shedding associated with a demand response program, the system comprising:
at least one power sensor configured to determine power consumption;
a processing circuitry; and
a memory, the memory containing instructions that, when executed by the processing circuitry, configure the system to:
set a power load shedding target;
analyze data related to power consumption of a plurality of loads of the system;
determine a configuration of a plurality of virtual switches associated with a corresponding plurality of physical switches, where each of the plurality of physical switches is configured to control power consumption of at least one load of a plurality of loads of the system;
simulate a power load shedding event based on the setup of a plurality of virtual switches and the analyzed data related to power consumption; and
adjust the configuration of the virtual switches when results of the simulating of a power load shedding event are not consistent with the power load shedding target.

21. The system of claim 20, wherein the system is further configured to:
collect from the plurality of power sensors information of power consumed by the plurality of loads, where each load of the plurality of loads is associated with a respective power sensor of the plurality of power sensors.

22. The system of claim 21, wherein the configuration of each of the plurality of virtual switches includes at least one of: an on position, and off position, and an intermediate position.

23. The system of claim 22, wherein the system is further configured to:
assign priority among the plurality of loads of the system with regard to the power load shedding event.
